(19) United States
(12) Patent Application Publication
(10) Pub. No.: US 2004/0194100 A1
(43) Pub. Date: Sep. 30, 2004

(54) Program execution controller and program transfer controller

(76) Inventors: Mikihiro Nakayama, Nagoya (JP); Toshikazu Umezu, Toki (JP); Satoru Tomida, Seto (JP); Chiharu Ogawa, Owariasahi (JP)

Correspondence Address: MCDERMOTT WILL & EMERY LLP, 600 13TH STREET, N.W., WASHINGTON, DC, 20005-3096, US

(21) Appl. No.: 10/449,699

(22) Filed: Jun. 2, 2003

(30) Foreign Application Priority Data
Jun. 7, 2002 (JP) 2002-167533(P)

(51) Int. Cl. G06F 9/46

(52) U.S. Cl. 718/100

(57) ABSTRACT

This invention addresses to prevent executions or transfers of unauthorized programs in an information processing apparatus.

The information processing apparatus includes following modules: an execution request monitor, a download request monitor, a user name acquiring module, a hash value calculator a program execution controller, a download controller, an execution policy, and a download policy. The program execution controller and the download controller control the execution and the download of programs by referring the execution policy and the download policy in which sets of information of the program name, the hash value and the user name are pre-registered therein as to programs to be permitted of the execution or the download.

### BACKGROUND OF THE INVENTION

1. Field of the Invention

This invention relates to controlling executions and transfers of computer programs.

2. Description of the Related Art

One of widely used technique nowadays is a computer network technology. But also widely spread are computer viruses. Various types of so called anti-virus programs are popular defense against the computer viruses infecting to computers. But anti-virus programs are less effective to unknown computer viruses.

Another technique that is recently utilized to prevent computer viruses is as follows: first, computer programs that are permitted of the execution are pre-registered into a security policy file; execution requests for computer programs are judged whether or not to be permitted; and the execution requests for non-registered computer programs are rejected.

### SUMMARY OF THE INVENTION

The latter technology is vulnerable to cases as follows: 1) the registered program is tampered or inappropriately modified; 2) the security policy file is tampered or inappropriately modified; and 3) a computer that is infected with an unauthorized computer program unintentionally transfers the unauthorized program to other computers via a network.

This invention addressed to solve above-described problems, and to prevent information processing apparatuses or computers that stores an unauthorized program from executing or transferring the unauthorized program.

This invention solve at least part of the above-described problem by following structures. A first embodiment of this invention as a program execution controller includes follows: an execution request monitor, a calculator, an execution policy storage, and a program execution controlling module. The execution request monitor is configured to monitor an execution request for the computer program and to acquire its program name. The calculator is configured to calculate a hash value of the program to be executed. The execution policy storage is configured to pre-store an execution policy, which determines a standard as to whether or not the execution request is to be permitted, in conjunction with the program name and the hash value. The execution controlling module is configured to determine whether or not the execution request is permitted based on the execution policy and to control the execution of the program.

Tampering the programs, which are registered in the execution policy, makes the hash value of the program varied. This invention keeps not only the program name in the execution policy, but also correct hash value, which ensures a protection against executing an unauthorized program.

The first embodiment of the program execution controller may include a user name acquiring module which is configured to acquire a user name of the user instructing the execution request. And the execution policy in the execution policy storage may be further related to the user name. This embodiment disenables unauthorized user instructing the unauthorized execution of computer program.

The first embodiment of the program execution controller may further include an execution log module which is configured to log a result of controlling of the execution controlling module. This embodiment enables a security operator of an information processing apparatus, which is installed with the program execution controller therein, to check whether or not unauthorized programs are stored therein. The execution log file may log all execution requests and may log only a part of them, e.g., execution requests for non-permitted computer program. The former log or logging all execution requests makes it possible to check whether or not inappropriate execution policy is determined.

A second embodiment of this invention as a program execution controller is described below. The second invention includes followings a first information processing module, a second information processing module, and a communication module. The first information processing module executes the computer program. The second information processing module executes processing except for executing the computer program. The communication module achieves communications between the first information processing module and the second information processing module. In the second embodiment, the first and the second information processing modules cannot communicate each other unless they use the communication module. And the first information processing module includes an execution request monitor that is configured to monitor an execution request of the computer program. The second information processing module includes followings: an execution policy storage that is configured to pre-store an execution policy, and an execution controlling module that is configured to determine whether or not the execution request is permitted based on the execution policy and to control the execution of the program.

In an information processing apparatus that is driven with multi operating system (OS), including an OS to be used for providing various services (hereinafter referred to as “Service OS”) and an OS to be used for security system (hereinafter referred to as “Security OS”), the first information processing module may correspond to a memory area for the Service OS and the second information processing module may correspond to a memory area for the Security OS. In an information processing apparatus with singly OS, the first information processing module may correspond to a memory area for the user mode and the second information processing module may correspond to a memory area for the kernel mode.

The second embodiment, where the second information processing module includes the execution policy storage, effectively prevents the execution policy to be tampered through inappropriate access from the first information processing module and execution of the unauthorized programs.

The first and second embodiment of the program execution controller may include a program acquiring module and an execution policy update module. The program acquiring module is configured to acquire a computer program and information to be added to the execution policy from a peripheral device. The execution policy update module is configured to add the information to the execution policy storage.

The acquisition from the peripheral device may include following manners: 1) acquiring from other information processing devices or servers through communication such as network, and 2) reading from recording media such as flexible disk. This embodiment enables update of the execution policy without maintenances by the security operator of the information processing apparatus, thereby enabling the user to execute the acquired program without delay. This enhances utility of the information processing apparatus and the execution controller.

Another embodiment of this invention as a first embodiment of a program transfer controller, which controls a transfer of a computer program to an information processing apparatus, is disclosed. The program transfer controller includes followings: a transfer request monitor, a calculator, a transfer policy storage, and a transfer controlling module. The transfer request monitor is configured to monitor a transfer request of the computer program and to acquire a program name of the computer program to be transferred. The calculator is configured to calculate a hash value of the program. The transfer policy storage is configured to pre-store a transfer policy, which determines a standard as to whether or not the transfer request is to be permitted, in conjunction with the program name and the hash value. The transfer controlling module is configured to determine whether or not the transfer request is permitted based on the transfer policy and to control the transfer of the program.

The program transfer controller prevents transfers of unauthorized programs, such as computer viruses, and tampered programs. The transfer request may be generated in the subjected-information processing apparatus that is installed with the program transfer controller and also in the other information processing apparatuses. The transfer includes various processes as follows: 1) in a client-server system, downloading computer programs from the server in response to the transfer request from the client, 2) uploading computer programs from the client to the server. In the former case, the transfer request is generated in the “other information processing apparatus”, and in the latter, the transfer request is generated in the “subjected-information processing apparatus”. The latter case may prevent computer viruses transferring and spreading the own copy to other information processing apparatuses.

The first embodiment of the program transfer controller may further include a user name acquiring module configured to acquire a user name of a user instructing the transfer request. And the transfer policy in the transfer policy storage may be further related to the user name.

And also the first embodiment of the program transfer controller further include a transfer log module configured to log a result of controlling of the transfer controlling module.

These structures achieves similar effects as described above for the program execution controller in this invention.

A second embodiment of the program transfer controller is disclosed below. The second embodiment of the program transfer controller includes followings: a first information processing module, a second information processing module, and a communication module. The first information processing module includes a transfer request monitor configured to monitor a transfer request of the computer program. And the second information processing module includes a transfer policy storage and a transfer controlling module. The transfer policy storage is configured to pre-store a transfer policy, which determines a standard as to whether or not the transfer request is to be permitted. The transfer controlling module is configured to determine whether or not the transfer request is permitted based on the transfer policy and to control the transfer of the program.

The second embodiment, where the second information processing module includes the transfer policy storage, effectively prevents the transfer policy to be tampered through inappropriate access from the first information processing module and transfers of the unauthorized programs. In a client-server system, for example, the server that is installed with the program transfer controller can effectively prevent transferring of harmful program based on an appropriate transfer policy. The client, which is installed with the program transfer controlling module, can effectively prevent transferring computer programs from and to unauthorized server based on an appropriate transfer policy.

In the first and second embodiment of the program transfer controller, the information processing apparatus may control an execution of the computer program based on an execution policy. And the transfer controlling module may transfers the computer program and information determining the execution policy to the information processing apparatus when the transfer request is permitted.

This embodiment enables update of the transfer policy without maintenances by the security operator of the information processing apparatus, thereby enhancing the utility of the information processing apparatus and the transfer controller.

In the case where the information processing apparatus can control transferring of the computer program based on the transfer policy, another embodiment of the first and second program transfer controller transfers the computer program and information determining the transfer policy to the information processing apparatus when the transfer request is permitted.

This causes the information processing apparatus automatically update the transfer policy according to the information transmitted from the program transfer controller, thereby enhancing the utility of the information processing apparatus.

Various modifications are applicable for this invention besides the program execution controller and the program transfer controller described above, such as a method controlling executions or transfers of computer programs. Other modifications includes followings: computer programs for executing such control by computer, recording media or a carrier wave in which such programs are recorded or carried. Various features described above are applicable in respect modifications.

In the case where this invention is structured, e.g., in forms of the computer programs or the recording medium in which the computer program is recorded, the computer program may include all components to control the program execution controller or the program transfer controller and may include part of them. Examples include a variety of computer-readable media, such as floppy disks, CD-ROM, DVD, magnetic optical disks, IC cards, ROM cartridges, punch cards, bar codes and other printed materials on which codes are printed, internal computer memory devices (memory such as RAM or ROM), and external memory devices.

### BRIEF DESCRIPTION OF THE DRAWINGS

FIG. 1 is a schematic that shows general configuration of a client-server system 1000 in the first embodiment.

FIG. 2 is a schematic that shows general configuration of the server 100 in the first embodiment.

FIG. 3 is a schematic that shows data structure of the execution policy 142.

FIG. 4 is a schematic that shows data structure of the download policy 144.

FIG. 5 is a schematic that shows data structure of the execution log 152.

FIG. 6 is a schematic that shows data structure of the download log 154.

FIG. 7 is a flowchart of the program execution process.

FIG. 8 is a flowchart of the download process.

FIG. 9 is a schematic that shows general configuration of a client-server system 1000A in the second embodiment.

### DESCRIPTION OF THE PREFERRED EMBODIMENTS

Some preferred embodiments of the present invention are discussed below.

A. System Configuration

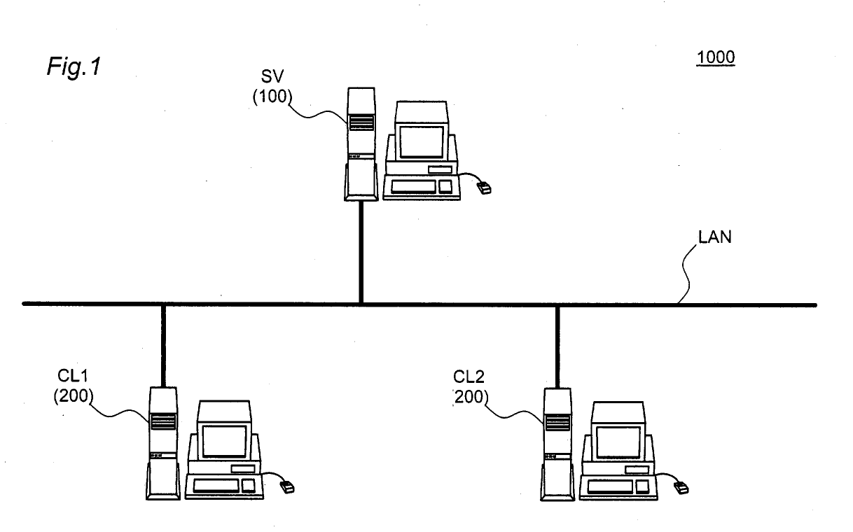

FIG. 1 is a schematic that shows general configuration of a client-server system 1000 in the first embodiment. A server SV, clients CL1 and CL2 corresponds to an information processing apparatus that is installed with the program execution controller and the program transfer controller of this invention. Hereinafter, for the sake of explanation, the server SV is referred as to server 100, and the client CL1 and CL2 are referred as to client 200. But both have same structures as a program execution controller and a program transfer controller. In this embodiment, the server 100 and the client 200 are connected with each other by a network LAN. The Internet is applicable to the network LAN.

The server 100 and the client 200 are computers with CPU, RAM and so on. These computers install various types of application programs (hereinafter simply referred to as “program”) and execute these programs in response to execution request by a user. The server 100 and the client 200 can perform transfers of programs, e.g., uploading and downloading, via the LAN. In this embodiment, transfers and executions of these programs in respect computers are limited by a security policy file described below.

B. Structure of Information Processing Apparatus

### 1st Embodiment

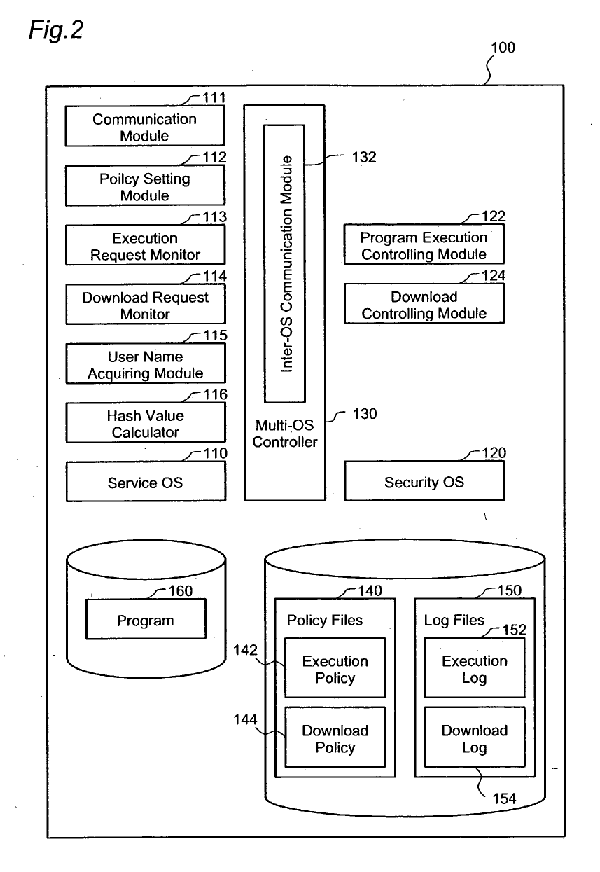

FIG. 2 is a schematic that shows general configuration of the server 100 in the first embodiment. The memory area that is managed by Service OS 110 is utilized to perform program 160 and following modules: a communication module 111, a policy setting module 112, an execution request monitor 113, a download request monitor 114, a user name acquiring module 115, and a hash value calculator 116. The program execution controlling module 122 and the download controlling module 124 performs on the memory area that is managed by Security OS 120. A security policy file 140 and a log file 150 are managed by the Security OS 120. The security policy file 140 stores an execution policy 142 and a download policy 144 as described later in detail. The log file 150 stores an execution log 152 and a download log 154 as described later in detail.

A multi-OS controller 130 performs various controls to let the Service OS 110 and the Security OS 120 perform on the server 100. The multi-OS controller 130 includes an Inter-OS communication module 132, which performs data communication between the Service OS 110 and the Security OS. The server 100 is designed to reject a direct access from any module on the Service OS 110 to the Security OS 120. As described above, the security policy file 140 is managed by the Security OS 120, which rejects the direct access from any module on the Service OS 110 to the security policy file 140. Thus, the execution policy 142 and the download policy 144 in the security policy file 140 are protected from being tampered by inappropriate access from any module on the Service OS 110.

Functions as a program execution controller are actualized by following function blocks: the execution request monitor 113, the user name acquiring module 115, the hash value calculator 116, and the program execution controlling module 122.

The execution request monitor 113 monitors the execution request of the programs and acquires the program name corresponding to the execution request. In response to the execution request, the user name acquiring module 115 acquires the user name of the user who instructs the execution request. The hash value calculator 116 calculates a hash value of the program to be executed in response to the execution request. These information, including the program name, the user name and the hash value, is transmitted to the program execution controlling module 122 through the Inter-OS communication module 132.

The program execution controlling module 122 determines whether or not the execution request is to be permitted and control the execution of the program by referring the execution policy 142 as to whether or not the parameter set of the program name, the user name, and the hash value are registered therein. The program execution controlling module 122 logs the execution log 152, which is the result of controlling the execution of the programs, into the log file 150 in the case where the execution request is to be rejected. The execution log 152 may be recorded when the execution request is to be permitted. In the latter case, execution logs for all of the execution requests are recorded, which makes it possible to check whether or not inappropriate execution policy is set.

Functions as a program transfer controller are actualized by following function blocks: the communication module 111, the execution request monitor 113, the user name acquiring module 115, the hash value calculator 116 and the program execution controlling module 122.

The download request monitor 114 monitors the download request from the client computer 200 and acquires the program name corresponding to the download request. The download request monitor 114 corresponds to the transfer request monitor of this invention. The user name acquiring module 115 acquires the user name of the user who instructs the download request in response to the download request. The hash value calculator 116 calculates the hash value of the program to be downloaded in response to the download request. These information, including the program name, the user name, and the hash value are transmitted to the download controlling module 124 through the Inter-OS communication module 132.

The download controlling module 124 determines whether or not the download request is to be permitted and controls the download by referring the download policy 144 as to whether or not the parameter set, including the program name, the user name and the hash value is registered therein. The download controlling module 124 corresponds to the transfer controller of this invention. The download controlling module 124 records the download log 154, which is the result of the control, into the log file 154 in the case where the download request is to be rejected. The download log 154 may be recorded when the download request is to be permitted. In the latter case, download logs for all of the download requests are recorded, which makes it possible to check whether or not inappropriate download policy is set.

The communication module 111 communicates to other devices or apparatuses, such as the client 200. The information transferred through the communication module 111 from and to the client 200 includes followings: e.g., programs, and information to be added to the execution policy 142 or the download policy 144. The communication module 111 corresponds to the program acquiring module in this invention.

The policy setting module 112 sets the execution policy 142 and the download policy 144, which are stored in the security policy file 140, according to instructions by the security operator. When the communication module 111 receives the information to be added to the execution policy 142 or the download policy 144 from the client 200, the policy setting module 112 automatically adds the information to the execution policy 142 and the download policy 144. This enables an automatic update of the execution policy 142 and the download policy 144 without instructions by the security operator, thereby enhancing utility of the server 100.

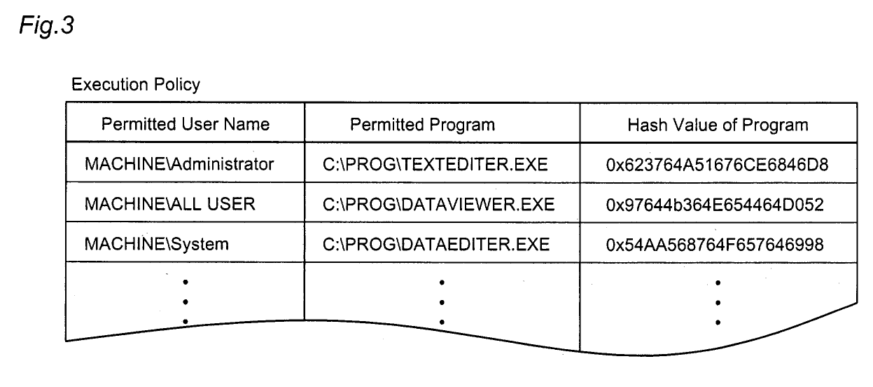

FIG. 3 is a schematic that shows data structure of the execution policy 142. In this embodiment, as shown in the figure, the execution policy 142 stores sets of the information regarding the program of which execution is to be permitted as follows: the program name, the hash value, and the user name who is authorized to instruct the execution of the program. The program execution controlling module 122 permits the execution of the program only in the case where the set of the information, the program name, the user name, and the hash value, which are transmitted from the execution request monitor 113, the user name acquiring module 115 and the hash value calculator 116, corresponds to the set registered in the execution policy 142. This technique, in which the strict execution policy 142 is determined and the execution of the program is controlled based on it, prevents executions of unauthorized programs.

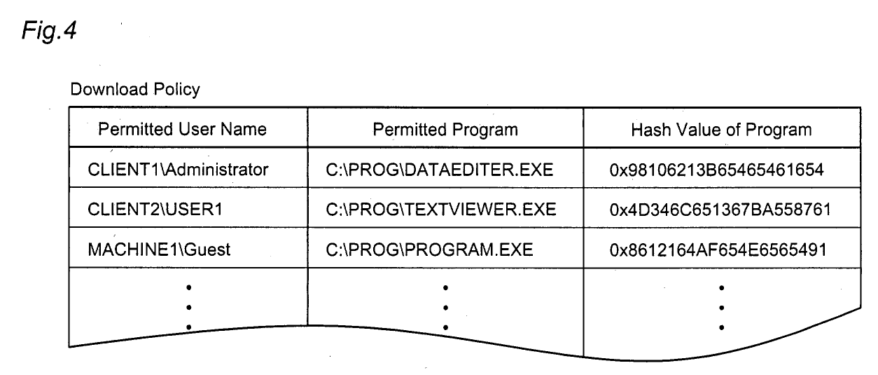

FIG. 4 is a schematic that shows data structure of the download policy 144. In this embodiment, as shown in the figure, the download policy 144 stores sets of the information regarding the program of which download is to be permitted as follows: the program name, the hash value, and the user name who is authorized to instruct the download of the program. The download controlling module 124 permits the download of the program only in the case where the set of the information, the program name, the user name, and the hash value, which are transmitted from the download request monitor 114, the user name acquiring module 115 and the hash value calculator 116, corresponds to the set registered in the download policy 144. This technique, in which the strict download policy 144 is determined and the download of the program is controlled based on it, prevents downloads of unauthorized programs.

The security policy file 140 corresponds to the execution policy storage and the transfer policy storage of the present invention.

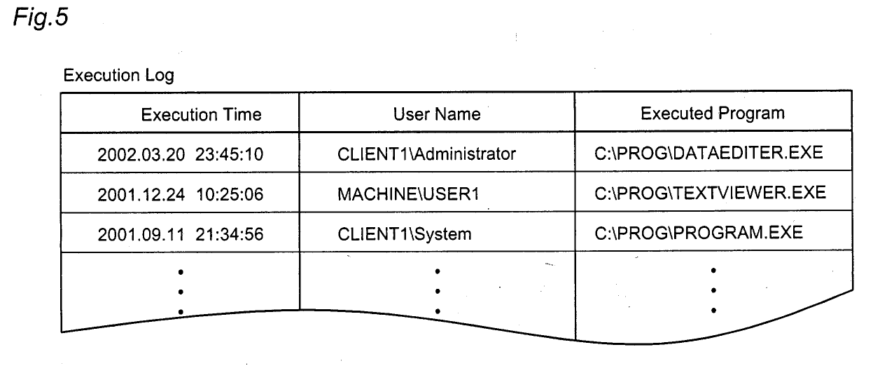

FIG. 5 is a schematic that shows data structure of the execution log 152. The execution log 152 is recorded, as described above, in the case where the program execution controlling module 122 rejects the execution request. In this embodiment, as shown in the figure, the execution log 152 logs the following information regarding the execution request: the date, the user name, and the program name. Recording the information in the execution log 152 enables the security operator of the server 100 to check whether or not execution requests for unauthorized programs are issued.

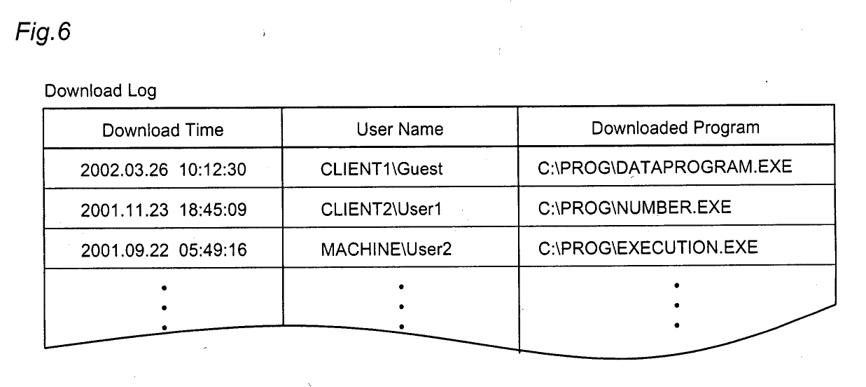

FIG. 6 is a schematic that shows data structure of the download log 154. The download log 154 is recorded, as described above, in the case where the download controlling module 124 rejects the download request. In this embodiment, as shown in the figure, the download log 154 logs the following information regarding the download request: the date, the user name and the program name. Recording the information in the download log 154 enables the security operator of the server 100 to check whether or not download requests for unauthorized programs are issued.

The log file 150, storing the execution log 152 and the download log 154, corresponds to the execution log module of present invention.

C. Program Execution Process

The server 100 performs a program execution process in the case where an execution request for any program installed therein. Performing the program execution process enables the server 100 to avoid executing of inappropriate programs, such as computer viruses and inappropriately tampered programs.

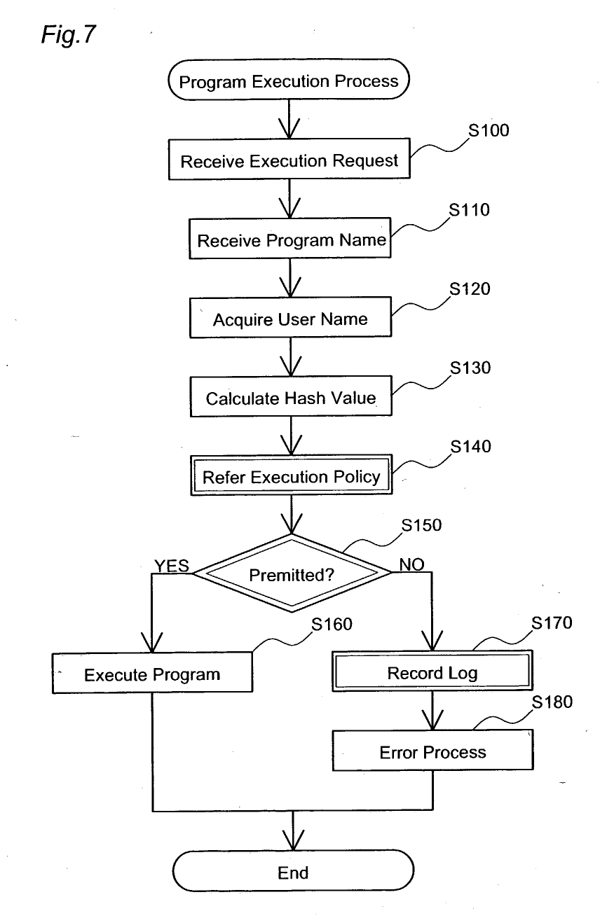

FIG. 7 is a flowchart of the program execution process, which is executed by CPU of the server 100. In this figure, depicted with single line box are steps executed by the Service OS, and with double line box are steps by the Security OS 120. The server 100 inputs the execution request of a program through a user's operation on the Service OS 110 (Step S100). Then the server 100 acquires the program name of the program of the execution request through the execution request monitor 113 (Step S110). The server 100 also acquires the user name of the execution request through the user name acquiring module 115 (Step S120). Then the server makes the hash value calculator 116 calculate the hash value of the program (Step S130).

The information, including the program name, the user name and the hash value, is transmitted to the Security OS 120 through the Inter-OS communication module 132. The program execution controlling module 122 refers the execution policy 142 whether or not the information set of the program name, the user name, and the hash value, is registered therein (Step S140) and determines whether or not the execution request is to be permitted (Step S150).

In the case where the execution request is to be permitted, the program execution controlling module 122 transmits a permission to the Service OS 110 through the Inter-OS communication module 132 and makes the Service OS 110 executes the program (Step S160). In the other case where the execution request is not to be permitted, the program execution controlling module 122 records the execution log 152 into the log file 150 (Step S170). And the program execution controlling module 122 transmits an instruction for an error process through the instruction to Inter-OS communication module 132, and makes the Service OS 110 perform predetermined error process (Step S180). The error process may delete the program and may indicate various error messages, such as “Program Execution Not Permitted”, “Unauthorized User for Execution”, and “Program Inappropriately Tampered”.

D. Download Process

The server 100 executes a download process in the case where an download request for any program installed therein. Performing the download process enables the server 100 to avoid downloading of inappropriate programs, such as computer viruses and inappropriately tampered programs.

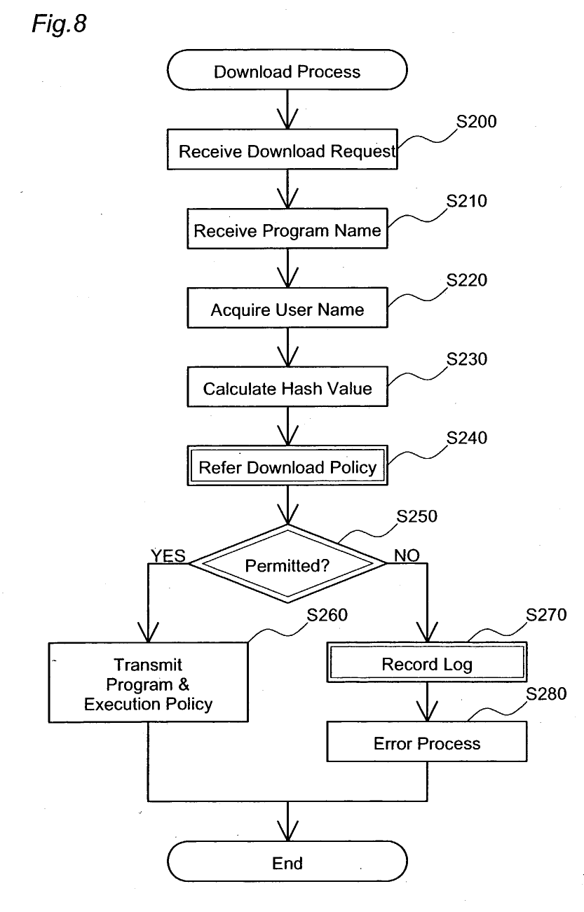

FIG. 8 is a flowchart of the download process, which is executed by CPU of the server 100. In this figure, depicted with single line box are steps executed by the Service OS, and with double line box are steps by the Security OS 120. The server 100 inputs the download request of a program through a user's operation on the Service OS 110 (Step S200). Then the server 100 acquires the program name of the program of the download request through the download request monitor 114 (Step S210). The server 100 also acquires the user name of the download request through the user name acquiring module 115 (Step S220). Then the server makes the hash value calculator 116 calculate the hash value of the program (Step S230).

The information, including the program name, the user name and the hash value, is transmitted to the Security OS 120 through the Inter-OS communication module 132. The program download controlling module 124 refers the download policy 144 whether or not the information set of the program name, the user name, and the hash value, is registered therein (Step S240) and determines whether or not the download request is to be permitted (Step S250).

In the case where the download request is to be permitted, the download controlling module 124 transmits a permission to the Service OS 110 through the Inter-OS communication module 132 and makes the Service OS 110 transmit the program and information to be added to the execution policy in the client 200 (Step S260). In this embodiment transmits the hash value of the transmitted program as the information to be added to the execution policy. The program name and the user name can be omitted, since the client 200 has got the information to issue the download request. The client 200 receives the hash value from the server 100, and automatically adds the hash value as well as already-known information, the program name and the user name, to the execution policy. This processing allows the client 200 to execute the downloaded program before the security operator updates the execution policy.

At step S250, in the case where the download request is not to be permitted, the download controlling module 124 records the download log 154 into the log file 150 (Step S270). And the download controlling module 124 transmits an instruction for an error process through the instruction to Inter-OS communication module 132, and makes the Service OS 110 perform predetermined error process (Step S280). The error process may delete the program according to the download request and may transmit various error messages to the client 200, such as “Download of the Program Not Permitted”, “Unauthorized User for Download”, and “Program Inappropriately Tampered”.

As described above, the server 100 stores the execution policy 142 and the download policy 144 in which strict regulations to execute or download programs according to the program name, the hash value and the user name. And the server 100 controls executing or downloading programs based on the execution policy 142 and the download policy 144, thereby preventing the execution and download of inappropriate programs. As described above, the client 200 can also actualize the same function as the program execution controller and the program transfer controller, thereby preventing the execution and transmission of inappropriate programs, such as computer viruses.

E. Information Processing Apparatus

### 2nd Embodiment

The information processing apparatus may install single OS, though the server 100 and the client 200 in the first embodiment installs multi-OS :the Service OS and the Security OS.

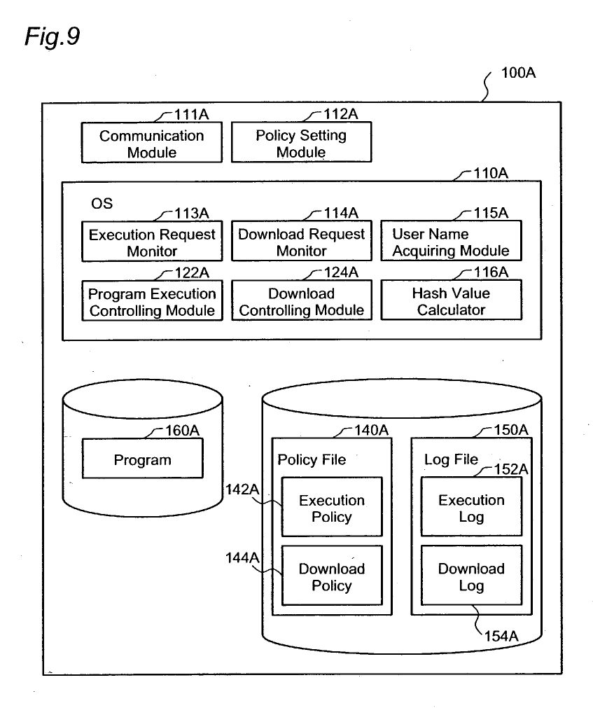

FIG. 9 is a schematic that shows general configuration of a client-server system 1000A in the second embodiment. Each unit illustrated in the figure performs similar function in the server 100 in the first embodiment. The flows of the program execution processing and the download processing are same of those in the first embodiment. Running on the user mod of the OS is the following modules: a communication module 111A, a policy setting module 112A, and a program 160A. Running on the kernel mode of the OS is the following modules: an execution request monitor 113A, a download request monitor 114A, a user name acquiring module 115A, a hash value calculator 116A, a program execution controlling module 122A and a download controlling module 124A. The execution request monitor 113A, the download request monitor 114A, the user name acquiring module 115A and the hash value calculator 116A may run on the user mode, since these modules don't directly access to a security policy file 140A.

The security policy file 140A and the log file 150A is managed by the OS 110A, thus these files cannot be directly accessed by any programs running on the user mode. This configuration can prevent inappropriately tampering the execution policy 142A and the download policy 144A in the security policy file 140A.

The server 100A in the second embodiment described above can effectively prevent the execution and the transmission of inappropriate programs, in a similar manner to the first embodiment.

F. Modifications

Some preferred embodiments are described above. This invention is not restricted with these embodiments and there may be various modifications without departing from the scope or spirit of the main characteristics of the present invention. By way of example, various modifications are described below.

F1. Modification 1

Though the execution policy and the download policy are determined according to the program name, the hash value, and the user name in the above-described embodiments, various determinations are applicable to each policy as long as the determination can prevent executions or transmissions of inappropriate programs.

F2. Modification 2

Though the server and the client in the above-described embodiments can achieve both functions of the program execution controller and the program download controller, one of those functions may be omitted for either one of the server and the client. By way of example, the server may function of the program transfer controller, and the client may function of the program execution controller.

F3. Modification 3

In the above-described embodiment, downloading program from the server 100 to the client 200 is described as an example of a transmission of programs. This invention may apply to uploading programs from the client 200 to the server 100. In this case, a transfer policy or an upload policy, which is determined so as to permit uploading to specified servers, prevents unauthorized upload to other servers.

The client may transmit the information to be added to the download policy 144 to the server 100 as well as transmission of the program. The server 100 automatically update the download policy 144.

F3. Modification 3

Though the server 100 stores the download policy in the above-described embodiments, the client 200 may store a policy to permit downloading from specified servers. This policy, for example, stores addresses or URLs of the specified servers. In this modification, the client 200 performs the similar processing to the download processing shown in FIG. 8 in response to the download request except for different parameters, which corresponds to the policy regarding the server, are used in step S210, S220 and S230. And at step S260, the download request is transmitted to the server. This processing enables the client 200 to prevent downloading programs from unauthorized servers.

This invention, as described above, enables information processing apparatuses to prevent executing and transferring inappropriate programs.

What is claimed is:

1. A program execution controller controlling an execution of a computer program in an information processing apparatus, comprising:
an execution request monitor configured to monitor an execution request for the computer program and to acquire its program name;
a calculator configured to calculate a hash value of the program to be executed;
an execution policy storage configured to pre-store an execution policy, which determines a standard as to whether or not the execution request is to be permitted, in conjunction with the program name and the hash value; and
a execution controlling module configured to determine whether or not the execution request is permitted based on the execution policy and to control the execution of the program.

2. A program execution controller according to claim 1, further comprising:
a user name acquiring module configured to acquire a user name of a user instructing the execution request;
wherein the execution policy in the execution policy storage is further related to the user name.

3. A program execution controller according to claim 1, further comprising:
an execution log module configured to log a result of controlling of the execution controlling module.

4. A program execution controller according to claim 1, further comprising:
a program acquiring module configured to acquire a computer program and information to be added to the execution policy from a peripheral device; and
an execution policy update module configured to add the information to the execution policy storage.

5. A program execution controller controlling an execution of a computer program in an information processing apparatus, comprising:
a first information processing module executing the computer program;
a second information processing module executing processing except for executing the computer program;
a communication module configured to communicate between the first information processing module and the second information processing module;
wherein the first information processing module includes an execution request monitor configured to monitor an execution request of the computer program;
wherein the second information processing module includes;
an execution policy storage configured to pre-store an execution policy, which determines a standard as to whether or not the execution request is to be permitted; and
a execution controlling module configured to determine whether or not the execution request is permitted based on the execution policy and to control the execution of the program.

6. A program execution controller according to claim 5, further comprising:
a program acquiring module configured to acquire a computer program and information to be added to the execution policy from a peripheral device; and
an execution policy update module configured to add the information to the execution policy storage.

7. A program transfer controller controlling a transfer of a computer program to an information processing apparatus comprising:
a transfer request monitor configured to monitor a transfer request of the computer program and to acquire a program name of the computer program to be transferred;
a calculator configured to calculate a hash value of the program;
a transfer policy storage configured to pre-store a transfer policy, which determines a standard as to whether or not the transfer request is to be permitted, in conjunction with the program name and the hash value; and
a transfer controlling module is configured to determine whether or not the transfer request is permitted based on the transfer policy and to control the transfer of the program.

8. A program transfer controller according to claim 7, further comprising:
a user name acquiring module configured to acquire a user name of a user instructing the transfer request;
wherein the transfer policy in the transfer policy storage is further related to the user name.

9. A program transfer controller according to claim 7, further comprising:
a transfer log module configured to log a result of controlling of the transfer controlling module.

10. A program transfer controller controlling a transfer of a computer program to an information processing apparatus comprising:
a first information processing module configured to control a communication with the information processing apparatus;
a second information processing module executing processing except for communicating with information processing apparatus;
a communication module configured to communicate between the first information processing module and the second information processing module;
wherein the first information processing module includes a transfer request monitor configured to monitor a transfer request of the computer program;
wherein the second information processing module includes:
a transfer policy storage configured to pre-store a transfer policy, which determines a standard as to whether or not the transfer request is to be permitted; and
a transfer controlling module configured to determine whether or not the transfer request is permitted based on the transfer policy and to control the transfer of the program.

11. A program transfer controller according to claim 10, wherein the information processing apparatus controls an execution of the computer program based on an execution policy, which determines whether or not an execution request of the computer program is to be permitted, and
the transfer controlling module transfers the computer program and information determining the execution policy to the information processing apparatus when the transfer request is permitted.

12. A program transfer controller according to claim 10, wherein the information processing apparatus controls a transfer of the computer program based on a transfer policy, which determines whether or not a transfer request of the computer program is to be permitted, and
the transfer controlling module transfers the computer program and information determining the transfer policy to the information processing apparatus when the transfer request is permitted.

13. A program transfer controller according to claim 10, further comprising:
a program acquiring module configured to acquire the computer program and information to be added to the transfer policy from a peripheral device; and
a transfer policy update module configured to add the information to the transfer policy storage.

14. A control method controlling an execution of a computer program in an information processing apparatus comprising:
a first step providing an execution policy, which determines a standard as to whether or not an execution request of the computer program is to be permitted, in conjunction with a program name and a hash value of the computer program;
a second step monitoring an execution request for the computer program and acquiring its program name;
a third step calculating the hash value of the program to be executed;
a fourth step determining whether or not the execution request is permitted based on the execution policy and controlling the execution of the program.

15. A control method controlling a transfer of a computer program to an information processing apparatus comprising:
a first step providing a transfer policy, which determines a standard as to whether or not a transfer request of the computer program is to be permitted, in conjunction with a program name and a hash value of the computer program;
a second step monitoring a transfer request for the computer program and acquiring its program name;
a third step calculating the hash value of the program to be transferred;
a fourth step determining whether or not the transfer request is permitted based on the transfer policy and controlling the transfer of the program.
